(19) United States
(12) Patent Application Publication
(10) Pub. No.: US 2015/0346009 A1
(43) Pub. Date: Dec. 3, 2015

(54) APPARATUS AND METHOD FOR DETECTING DECLINE OF FUEL EFFICIENCY OF VEHICLE

(71) Applicant: Kia Motors Corporation, Seoul (KR)

(72) Inventors: Sung Sam Chun, Seoul (KR); Seung-Chang Park, Seoul (KR)

(73) Assignee: Kia Motors Corporation

(21) Appl. No.: 14/565,651

(22) Filed: Dec. 10, 2014

(30) Foreign Application Priority Data
Jun. 3, 2014 (KR) 10-2014-0067630

(51) Int. Cl. G01F 9/02; F02M 65/00

(52) U.S. Cl. CPC G01F 9/023; F02M 65/001

(57) ABSTRACT

An apparatus and method for detecting a decline of fuel efficiency performance of a vehicle are provided. The method includes setting, by a controller, a fuel efficiency measuring reference mode and measuring average fuel efficiency based on data for each item based on the fuel efficiency measuring reference mode. Whether the fuel efficiency performance is declined is determined based on the average fuel efficiency measured value. A controlling apparatus that causes the decline of fuel efficiency is determined using data of the decline of fuel efficiency performance. In addition, a notification is output that provides the controlling apparatus causing the decline of fuel efficiency performance.

### CROSS-REFERENCE TO RELATED APPLICATION

This application claims priority to and the benefit of Korean Patent Application No. 10-2014-0067630 filed in the Korean Intellectual Property Office on Jun. 3, 2014, the entire contents of which are incorporated herein by reference.

### BACKGROUND

1. (a) Field of the Invention

The present invention relates to an apparatus and a method for detecting a decline of fuel efficiency of a vehicle.

2. (b) Description of the Related Art

Fuel efficiency performance of a vehicle is determined based on traffic conditions, road characteristics, driving habits, age of parts within the vehicle, and other environmental factors. Conventionally, the fuel efficiency performance of the vehicle has been estimated by considering these factors in a complex manner, but there is a need to more accurately detect factors of the decline of fuel efficiency performance to efficiently manage the vehicle.

A developed method in the related art discloses a method in which a fuel efficiency decline is determined based on a result obtained by comparing average values of current fuel efficiency based on fuel efficiency of past learning routes and an alarm for a routine inspection is output once the decline of fuel efficiency is detected. This method may however not accurately detect the factor of the decline of fuel efficiency performance.

The above information disclosed in this section is merely for enhancement of understanding of the background of the invention and therefore it may contain information that does not form the prior art that is already known in this country to a person of ordinary skill in the art.

### SUMMARY

The present invention provides an apparatus and a method for detecting a decline of fuel efficiency of a vehicle having advantages of performing a vehicle management capable of maintaining an optimal fuel efficiency state. Exemplary embodiments of the present invention may be used to achieve other objects which are not specifically stated, in addition to the above object.

An exemplary embodiment of the present invention provides an apparatus for detecting a decline of fuel efficiency performance that may include: a reference mode setting unit configured to set a fuel efficiency measuring reference mode; a fuel efficiency measuring unit configured to measure average fuel efficiency based on data for each item based on the fuel efficiency measuring reference mode; a data evaluating unit configured to determine whether the fuel efficiency performance is declined based on the average fuel efficiency measured value; a fuel efficiency decline factor extracting unit configured to determine a controlling apparatus causing the decline of fuel efficiency performance including data of the decline of fuel efficiency performance; and a vehicle management guiding unit configured to inform the controlling apparatus causing the decline of fuel efficiency performance.

The apparatus may further include a data collecting unit configured to collect the data for each item based on the fuel efficiency measuring reference mode upon driving a vehicle and collect the data of the decline of fuel efficiency performance from a plurality of controlling apparatuses. The data for each item may include at least one of a vehicle speed, a driving distance, a coolant temperature, an outdoor temperature, humidity, a vehicle height, an engine load, an engine revolution per minute (RPM), indicated horsepower, net horsepower, a gear stage, a battery voltage, a tire pressure, an idle time, an actual driving time, and a fuel consumption amount. In addition, the data evaluating unit may be configured to calculate a change amount in the average fuel efficiency based on the average fuel efficiency measured value and determine whether the fuel efficiency performance is declined based on the change amount in the average fuel efficiency.

When an absolute value of the change amount in the average fuel efficiency exceeds a preset value, the data evaluating unit may be configured to determine the fuel efficiency performance to be abnormal (e.g., less than a desired fuel efficiency). The fuel efficiency decline factor extracting unit may then be configured to determine whether the controlling apparatus is normal or abnormal based on a result obtained by comparing the data of the decline of fuel efficiency performance with a reference value of the controlling apparatus declining fuel efficiency for each vehicle model. The apparatus may further include an engine controlling unit and a tire pressure monitoring system. The apparatus may be interworked with a data collecting apparatus including an engine controlling unit (ECU, e.g., a controller), a tire pressure monitoring system, and a data collecting unit.

Another exemplary embodiment of the present invention provides a method for detecting a decline of fuel efficiency performance that may include: setting a fuel efficiency measuring reference mode in a vehicle or at a remote center to transmit the reference mode to the vehicle; collecting data for each item based on the fuel efficiency measuring reference mode upon driving the vehicle and collecting data of the decline of fuel efficiency performance from a plurality of controlling apparatuses; measuring average fuel efficiency based on the data for each item; determining whether the fuel efficiency performance is declined based on the average fuel efficiency measured value; determining a controlling apparatus including data of the decline of fuel efficiency performance and detecting a factor of the decline of fuel efficiency; and informing the controlling apparatus causing the decline of fuel efficiency performance.

The collection of the data may be performed within the vehicle and other steps may be performed extraneous to the vehicle. In the determination of whether the fuel efficiency performance is declined, a change amount in the average fuel efficiency may be calculated based on the average fuel efficiency measured value and whether the fuel efficiency performance is declined may be determined based on the change amount in the average fuel efficiency.

In the determination of whether the fuel efficiency performance is declined, when an absolute value of the change amount in the average fuel efficiency exceeds a preset value, the fuel efficiency performance may be determined to be abnormal. In the detection of the factor of the decline of fuel efficiency, whether the controlling apparatus is normal or abnormal may be determined based on a result obtained by comparing the data of the decline of fuel efficiency performance with a reference value of the controlling apparatus declining fuel efficiency for each vehicle model. According to an exemplary embodiment of the present invention, the vehicle management capable of maintaining the optimal fuel efficiency state may be performed.

### BRIEF DESCRIPTION OF THE DRAWINGS

The attached drawings illustrate exemplary embodiments of the present invention, provided for describing the present invention in more detail, but not for limiting technical aspects of the present invention.

FIG. 1 illustrates an exemplary apparatus for detecting a decline of fuel efficiency performance according to an exemplary embodiment of the present invention;

FIG. 2 illustrates an exemplary data collecting apparatus and an apparatus for detecting a decline of fuel efficiency performance according to an exemplary embodiment of the present invention;

FIG. 3 is an exemplary illustration of angular velocity data of normal cylinders according to an exemplary embodiment of the present invention;

FIG. 4 is an exemplary illustration of angular velocity data of a cylinder having abnormal cylinders according to an exemplary embodiment of the present invention; and

FIG. 5 illustrates an exemplary method for detecting a decline of fuel efficiency performance according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention will be described in detail with reference to the accompanying drawings so that those skilled in the art may easily practice the present invention. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification. In addition, the detailed description of the widely known technologies will be omitted.

In the entire specification, the term “reference mode” means related information based on data which may be collected within a vehicle necessary to measure fuel efficiency and includes information such as road conditions, vehicle speed, a driving distance, a driving time, and the like.

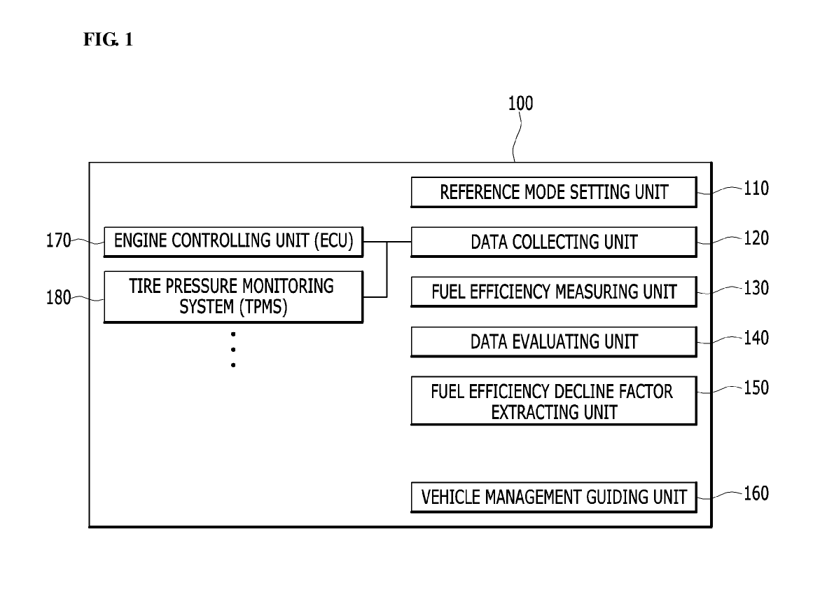

FIG. 1 is an exemplary apparatus for detecting a decline of fuel efficiency performance according to an exemplary embodiment of the present invention. As shown in FIG. 1, an apparatus 100 for detecting a decline of fuel efficiency performance may include a reference mode setting unit 110, a data collecting unit 120, a fuel efficiency measuring unit 130, a data evaluating unit 140, a fuel efficiency decline factor extracting unit 150, a vehicle management guiding unit 160, an engine controlling unit (e.g., a controller) 170, a tire pressure monitoring system 180, and the like. The controller 170 may be configured to operate the reference mode setting unit 110, the data collecting unit 120, the fuel efficiency measuring unit 130, the data evaluating unit 140, the fuel efficiency decline factor extracting unit 150, the vehicle management guiding unit 160, and the tire pressure monitoring system 180. Alternatively, the units may be operated by a second controller and the ECU and the tire pressure monitoring system may be disposed separately.

The reference mode setting unit 110 may be configured to set a reference mode related to information based on data collected within a vehicle (e.g., using various sensors mounted within the vehicle) to measure the fuel efficiency. The reference mode may be set within the vehicle, and may be set at a vehicle managing center which may be remote and may be transmitted to the apparatus 100 for detecting the decline of fuel efficiency performance within the vehicle via wireless communication with the vehicle.

The data collecting unit 120 may be configured to collect data for each item based on a fuel efficiency measuring reference mode upon driving the vehicle and collect data related to the decline of fuel efficiency from a plurality of controlling apparatuses (e.g., various control apparatuses within the vehicle that operate various vehicle components). The data for each item, which is a value related to the set reference mode, may be data collected within the vehicle necessary to measure the fuel efficiency. The data for each item may include at least one data of the group consisting of: a vehicle speed, a driving distance, a coolant temperature, an outdoor temperature, humidity, a vehicle height, an engine load, an engine revolution per minute (RPM), indicated horsepower, net horsepower, a gear stage, a battery voltage, a tire pressure, an idle time, an actual driving time, a fuel consumption amount, and the like.

The engine controlling unit 170, the tire pressure monitoring system 180, and the like may be configured to transmit data related to the decline of fuel efficiency collected by sensors to the data collecting unit 120. For example, the data related to the decline of fuel efficiency may include a change in power performance of an engine in a predetermined condition, a change in angular velocity upon an explosion stroke for each cylinder, an air-fuel ratio learning value, a change in torque of the engine, a change in the tire pressure, or the like. The fuel efficiency measuring unit 130 may be configured to measure average fuel efficiency based on the data for each item.

The data evaluating unit 140 may be configured to determine whether the fuel efficiency performance is declined based on the average fuel efficiency measured value. As a method of determining whether the fuel efficiency performance is declined, a change in the average fuel efficiency may be calculated based on the average fuel efficiency measured value and whether the fuel efficiency performance is declined may be determined based on the calculated change in the average fuel efficiency. Specifically, when an absolute value of the change in the average fuel efficiency exceeds a preset value, the fuel efficiency performance may be determined to be abnormal (e.g., the fuel efficiency is less than a predetermined value).

The following Tables 1 and 2 are illustrations of values of data for each item for measuring the fuel efficiency according to the reference mode and values for determining whether the fuel efficiency performance is declined.

TABLE 1

| Conditional | | | | | | | | | | | Indicated |
|---|---|---|---|---|---|---|---|---|---|---|---|
| Variable | | Driving | Vehicle | Driving | Coolant | Outdoor | | Vehicle | Engine | Engine | Horsepower |
| Measurement Mode | | Mode | Speed | Distance | Temperature | Temperature | Humidity | Height | Load | RPM | (Max.) |
| City- | unload | CA | 10-20 | 10 km | 80-90° C. | 20° C. | 30-50% | 2 mm | 50 or | 400-3500 | 80% |
| Drive | Situation | | | | | | | | less | | |
| Mode | | | | | | | | | | | |
| City- | unload | CB | 30-40 | NA | NA | NA | NA | NA | NA | NA | NA |
| Drive | Situation | | | | | | | | | | |
| Mode | | | | | | | | | | | |
| City- | unload | CC | 50-60 | NA | NA | NA | NA | NA | NA | NA | NA |
| Drive | Situation | | | | | | | | | | |
| Mode | | | | | | | | | | | |
| City- | unload | CD | 70-100 | NA | NA | NA | NA | NA | NA | NA | NA |
| Drive | Situation | | | | | | | | | | |
| Mode | | | | | | | | | | | |
| City- | Load | CA_1 | 10-20 | NA | NA | NA | NA | NA | NA | NA | NA |
| Drive | Situation | | | | | | | | | | |
| Mode | | | | | | | | | | | |
| City- | Load | CB_2 | 30-40 | NA | NA | NA | NA | NA | NA | NA | NA |
| Drive | Situation | | | | | | | | | | |
| Mode | | | | | | | | | | | |
| City- | Load | CC_3 | 50-60 | NA | NA | NA | NA | NA | NA | NA | NA |
| Drive | Situation | | | | | | | | | | |
| Mode | | | | | | | | | | | |
| City- | Load | CC_4 | 70-100 | NA | NA | NA | NA | NA | NA | NA | NA |
| Drive | Situation | | | | | | | | | | |
| Mode | | | | | | | | | | | |
| Highway | unload | HA | 70-80 | NA | NA | NA | NA | NA | NA | NA | NA |
| | Situation | | | | | | | | | | |
| Highway | unload | HB | 80-100 | NA | NA | NA | NA | NA | NA | NA | NA |
| | Situation | | | | | | | | | | |
| Highway | unload | HC | 100-120 | NA | NA | NA | NA | NA | NA | NA | NA |
| | Situation | | | | | | | | | | |
| Highway | Load | HA_1 | 70-80 | NA | NA | NA | NA | NA | NA | NA | NA |
| | Situation | | | | | | | | | | |
| Highway | Load | HA_2 | 80-100 | NA | NA | NA | NA | NA | NA | NA | NA |
| | Situation | | | | | | | | | | |
| Highway | Load | HA_3 | 100-120 | NA | NA | NA | NA | NA | NA | NA | NA |
| | Situation | | | | | | | | | | |

TABLE 2

| | | | | | | | | | | Change | |
|---|---|---|---|---|---|---|---|---|---|---|---|
| | | | | | | | | | | Amount in | |
| | | | | | | | | | Measured | Previous | Reference of |
| | | | | | | | | | Average | Trip | Determining |
| Conditional | | Net | | | Tire | | Actual | Fuel | Fuel | Average | Decline of |
| Variable | | Horsepower | Gear | Battery | Pressure | Idle | Driving | Consumption | Efficiency | Fuel | Fuel |
| Measurement Mode | | (Max.) | Stage | Voltage | (4 wheels) | Time | Time | Amount (ml) | (Km/L) | Efficiency | Efficiency |
| City- | unload | 70% | 4-5 | 13-14.5 V | 30 Psi | 10 | 20 | 400 | 14 | 13 | Previous |
| Drive | Situation | | stage | | 29 Psi | minutes | minutes | | | | Trip Fuel |
| Mode | | | | | 31 Psi | | | | | | Efficiency |
| | | | | | 30 Psi | | | | | | 10% or less |
| City- | unload | NA | NA | NA | NA | NA | NA | NA | NA | NA | NA |
| Drive | Situation | | | | | | | | | | |
| Mode | | | | | | | | | | | |
| City- | unload | NA | NA | NA | NA | NA | NA | NA | NA | NA | NA |
| Drive | Situation | | | | | | | | | | |
| Mode | | | | | | | | | | | |
| City- | unload | NA | NA | NA | NA | NA | NA | NA | NA | NA | NA |
| Drive | Situation | | | | | | | | | | |
| Mode | | | | | | | | | | | |
| City- | Load | NA | NA | NA | NA | NA | NA | NA | NA | NA | NA |
| Drive | Situation | | | | | | | | | | |
| Mode | | | | | | | | | | | |
| City- | Load | NA | NA | NA | NA | NA | NA | NA | NA | NA | NA |
| Drive | Situation | | | | | | | | | | |
| Mode | | | | | | | | | | | |
| City- | Load | NA | NA | NA | NA | NA | NA | NA | NA | NA | NA |
| Drive | Situation | | | | | | | | | | |
| Mode | | | | | | | | | | | |
| City- | Load | NA | NA | NA | NA | NA | NA | NA | NA | NA | NA |
| Drive | Situation | | | | | | | | | | |
| Mode | | | | | | | | | | | |
| Highway | unload | NA | NA | NA | NA | NA | NA | NA | NA | NA | NA |
| | Situation | | | | | | | | | | |
| Highway | unload | NA | NA | NA | NA | NA | NA | NA | NA | NA | NA |
| | Situation | | | | | | | | | | |
| Highway | unload | NA | NA | NA | NA | NA | NA | NA | NA | NA | NA |
| | Situation | | | | | | | | | | |
| Highway | Load | NA | NA | NA | NA | NA | NA | NA | NA | NA | NA |
| | Situation | | | | | | | | | | |
| Highway | Load | NA | NA | NA | NA | NA | NA | NA | NA | NA | NA |
| | Situation | | | | | | | | | | |
| Highway | Load | NA | NA | NA | NA | NA | NA | NA | NA | NA | NA |
| | Situation | | | | | | | | | | |
| Highway | Load | | | | | | | | | | |
| | Situation | | | | | | | | | | |

In Tables 1 and 2, NA is indicated because additional illustrative values are not required, and the above-mentioned values are illustrative values which may be varied depending on vehicle models and several environmental factors. Referring to Tables 1 and 2, the driving mode may be classified based on whether the vehicle is in a city-driving mode and a highway driving mode, is in an unload situation and a load situation, and a vehicle speed in the vehicle to measure fuel efficiency.

In addition, within the vehicle, the fuel efficiency measuring unit 130 may be configured to measure average fuel efficiency using a data value for each item collected by the data collecting unit 120, and the data evaluating unit 140 may be configured to calculate a change in the average fuel efficiency based on the measured average fuel efficiency. The data evaluating unit 140 may be configured to determine whether the fuel efficiency is declined according to a reference of determining the decline of fuel efficiency indicated in Table 2 using the calculated change in the average fuel efficiency.

The fuel efficiency decline factor extracting unit 150 may be configured to determine the controlling apparatus causing the decline of fuel efficiency including the data related to the decline of fuel efficiency. When the data evaluating unit 140 determines that the fuel efficiency performance is declined, the fuel efficiency decline factor extracting unit 150 may be configured which controlling apparatus is related to the decline of fuel efficiency.

As a method of determining the controlling apparatus related to the decline of fuel efficiency, whether the controlling apparatus related to the decline of fuel efficiency is normal or abnormal may be determined based on a result obtained by comparing the data related to the decline of fuel efficiency with a reference value of the controlling apparatus related to a decline of fuel efficiency for each vehicle model.

The vehicle management guiding unit 160 may be configured to determine which the controlling apparatus causes the decline of fuel efficiency and inform a driver of that controlling apparatus causing such a decline. Specifically, the controlling apparatus may be a component within the vehicle related to the decline of fuel efficiency, and may be a component such as a tire, a cylinder, or the like. The following Table 3 is a detailed illustration of determining whether the controlling apparatus related to the decline of fuel efficiency is normal (e.g., operating without a failure) or abnormal (e.g., operating with a failure).

TABLE 3

| | | | | | | Reference of | | |
|---|---|---|---|---|---|---|---|---|
| | | Reference value | | Measured | | Evaluating | | |
| Collecting | Controller Data | for each Vehicle | | Value on | | Decline of Fuel | | |
| Item | Name | Model | | Driving | | Efficiency | Result | Note |
| Engine | Indicated engine | 97% | | 95% | | reference | OK | |
| Indicated | torque | | | | | value 10% | | |
| Horsepower | | | | | | or less | | |
| (Idle) | | | | | | | | |
| Engine Net | Torque of Friction | 85% | | 82% | | reference | OK | |
| Horsepower | | | | | | value 10% | | |
| (upon | | | | | | or less | | |
| shifting | | | | | | | | |
| 1->2) | | | | | | | | |
| Tire | Sensor | 30 | psi | 29 | psi | reference | OK | |
| Pressure | Pressure(FL) | | | | | value ±5% | | |
| | | | | | | or less | | |
| Tire | Sensor | 30 | psi | 31 | psi | reference | OK | |
| Pressure | Pressure(FR) | | | | | value ±5% | | |
| | | | | | | or less | | |
| Tire | Sensor | 30 | psi | 28 | psi | reference | NG | Alarm |
| Pressure | Pressure(RL) | | | | | value ±5% | | Check |
| | | | | | | or less | | |
| Tire | Sensor | 30 | psi | 27 | psi | reference | NG | Alarm |
| Pressure | Pressure(RR) | | | | | value ±5% | | Check |
| | | | | | | or less | | |
| Air/Fuel | Fuel | ±50% | | −10% | | reference | OK | |
| Ratio | Adaption(IDLE) | | | | | value ±50% | | |
| Learning | | | | | | or more | | |
| Value | | | | | | | | |
| Air/Fuel | Fuel | ±50% | | +28% | | reference | NG | Alarm |
| Ratio | Adaption(Part | | | | | value ±50% | | Check |
| Learning | load) | | | | | or more | | |
| Value | | | | | | | | |
| Knocking | Knock Adaption | ±10° | C.RK | +3° | C.RK | reference | OK | |
| Learning | 1Cy1 | | | | | value ±80% | | |
| Value | | | | | | or more | | |
| Knocking | Knock Adaption | ±10° | C.RK | −5° | C.RK | reference | OK | |
| Learning | 2Cy1 | | | | | value ±80% | | |
| Value | | | | | | or more | | |
| Knocking | Knock Adaption | ±10° | C.RK | +9° | C.RK | reference | NG | |
| Learning | 3Cy1 | | | | | value ±80% | | |
| Value | | | | | | or more | | |
| Knocking | Knock Adaption | ±10° | C.RK | +3° | C.RK | reference | OK | |
| Learning | 4Cy1 | | | | | value ±80% | | |
| Value | | | | | | or more | | |

| | | | | | | | |
|---|---|---|---|---|---|---|---|
| Angular | Engine | Collected Data | +320 | us | reference | OK | |
| Velocity of | Roughness Value | Average Value | | | value −70% | | |
| Cylinder | 1Cy1 | (±1200 us) | | | or less | | |
| Angular | Engine | Collected Data | −920 | us | reference | NG | Alarm |
| Velocity of | Roughness Value | Average Value | | | value −70% | | Check |
| Cylinder | 1Cy2 | (±1200 us) | | | or less | | |
| Angular | Engine | Collected Data | +220 | us | reference | OK | |
| Velocity of | Roughness Value | Average Value | | | value −70% | | |
| Cylinder | 1Cy3 | (±1200 us) | | | or less | | |
| Angular | Engine | Collected Data | +300 | us | reference | OK | |
| Velocity of | Roughness Value | Average Value | | | value −70% | | |
| Cylinder | 1Cy4 | (±1200 us) | | | or less | | |

Table 3 illustrates a detailed method of determining whether the vehicle part is abnormal, and the respective values are illustrative values which may be varied based on the vehicle models and other factors. For example, in response to determining whether a tire is abnormal (e.g., tire pressure is less than a predetermined value or another failure has occurred), whether the tire is abnormal may be determined by tire pressure values of four wheels. When a reference value of the tire pressure for each vehicle model is about 30 psi and a reference for evaluating the decline of fuel efficiency is ±5% or less of a reference value, when pressure of a tire of a left rear wheel measured upon the driving is about 28 psi, the fuel efficiency decline factor extracting unit 150 may be configured to determine that the tire of the left rear wheel is abnormal. In particular, the vehicle management guiding unit 160 may be configured to notify the driver the check the tire of the left rear wheel (e.g., output a notification indicating where a failure has occurred).

As another example, a process of determining whether the air/fuel ratio is abnormal will be described using the air/fuel ratio learning value of the engine. When the air/fuel ratio reference value for each vehicle model is ±50% and the reference of evaluating the decline of fuel efficiency is ±50% or greater of the reference value, since the air/fuel ratio is +25% or greater when the air/fuel ratio learning value is +28%, the air/fuel ratio may be determined to be abnormal.

As still another example, a process of determining whether a knocking is abnormal will be described using a knocking learning value of the engine. When the reference value for each vehicle model is ±10° C.RK and the reference of evaluating the decline of fuel efficiency is ±80% or greater of the reference value, since the knocking is +8° C.RK or greater when the knocking learning value is +9° C.RK, the knocking may be determined to be abnormal.

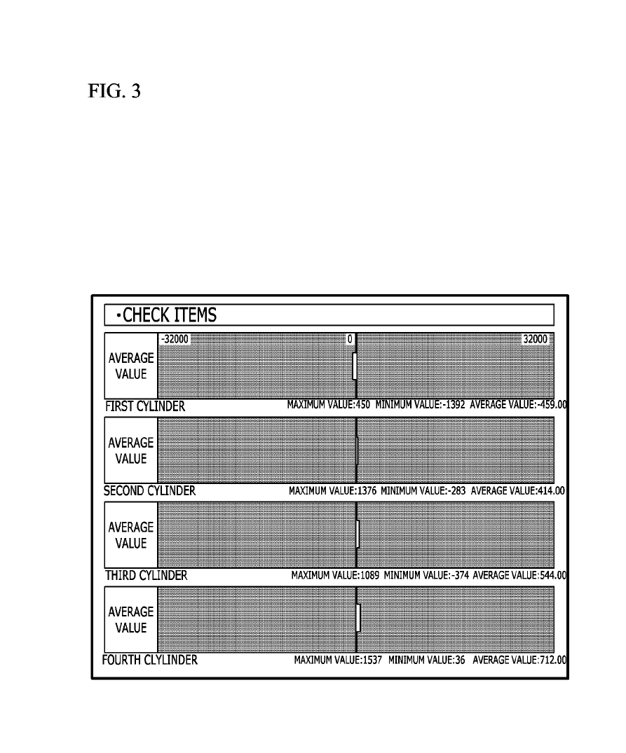

Further, in another example, whether a cylinder of the engine is abnormal may be determined using angular velocity of the cylinder. In particular, when a reference value of the angular velocity of the cylinder for each vehicle model is ±1200 us, which is an average value of the collected data and the reference of evaluating the decline of fuel efficiency is −70% or less of the reference value, when an angular velocity measured value of the cylinder is −840 us or less, the cylinder may be determined to be abnormal. In Table 3, since the angular velocity measured value of a second cylinder is −920 us, which is a value of −840 us or less, the fuel efficiency decline factor extracting unit 150 may be configured to determine that the second cylinder is abnormal, and the vehicle management guiding unit 160 may be configured to inform (e.g., output a notification) the driver to check the second cylinder. FIG. 3, which is an illustration of angular velocity data of normal cylinders according to an exemplary embodiment of the present invention, shows, values of when an average value of the measured angular velocity of the cylinder is determined to be normal according to the reference of evaluating the decline of fuel efficiency. The values shown in the drawing are illustrative values according to an exemplary embodiment, which may be different values from the values shown in the drawing depending on the various scenarios.

FIG. 3 shows a range value of an angular velocity of each cylinder from −32000 to 32000. A first cylinder may have a maximum value of the angular velocity of about 450, a minimum value of about −1392, and an average value of about −459, and the second cylinder may have a maximum value of the angular velocity of about 1376, a minimum value of about −283, and an average value of about 414. A third cylinder may have a maximum value of the angular velocity of about 1069, a minimum value of about −374, and an average value of about 544, and a fourth cylinder may have a maximum value of the angular velocity of about 1537, a minimum value of about 36, and an average value of about 712. With the above values, the average value of the angular velocity of each cylinder may be determined to be normal according to the reference of evaluating the decline of fuel efficiency.

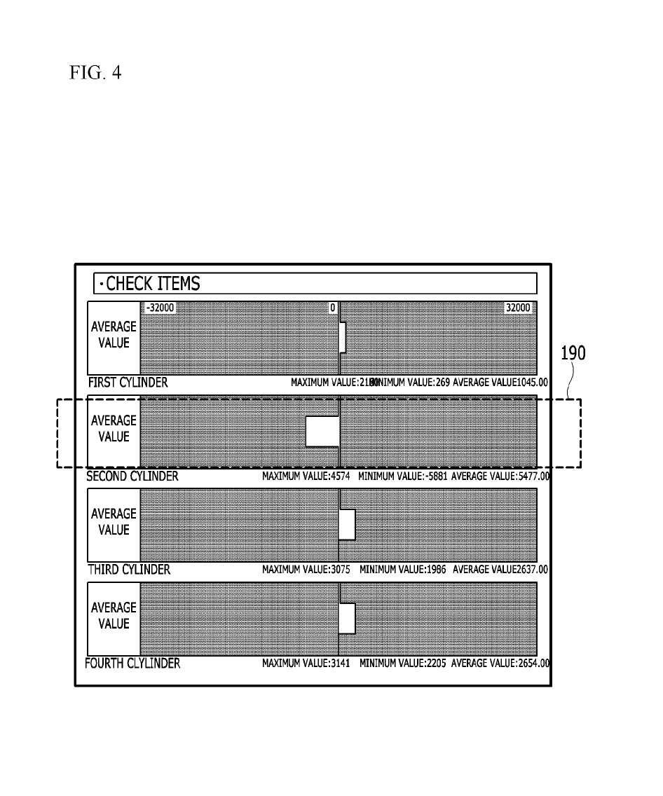

FIG. 4, which is an illustration of angular velocity data of a cylinder having abnormal cylinders according to an exemplary embodiment of the present invention, similarly shows that the values shown in the drawing are illustrative values according to an exemplary embodiment, which may be different values from the values shown in the drawing based on the various scenarios.

The first cylinder may have a maximum value of the angular velocity of about 2160, a minimum value of 269, and an average value of about 1045, and the second cylinder may have a maximum value of the angular velocity of about −4574, a minimum value of about −5681, and an average value of about −5477. The third cylinder may have a maximum value of the angular velocity of about 3076, a minimum value of about 1986, and an average value of about 2637, and the fourth cylinder may have a maximum value of the angular velocity of about 3141, a minimum value of about 2205, and an average value of about 2654. Since the measured average value (190) of the angular velocity of the second cylinder is a greater a negative value than the reference value, the second cylinder may be determined to be abnormal according to the reference of evaluating the decline of fuel efficiency.

The engine controlling unit (ECU) 170 and the tire pressure monitoring system (TPMS) 180 may respectively be configured to measure data related to the decline of fuel efficiency which may be measured by the sensor within the engine and an air pressure value of the tire related to the decline of fuel efficiency using the sensor in the tire and transmit the data to the data collecting unit 120. Although the controlling apparatus such as the engine controlling unit (ECU) 170, the tire pressure monitoring system 180, or the like may be included in the apparatus for detecting the decline of fuel efficiency performance as shown in FIG. 1, it may be separated from the apparatus for detecting the decline of fuel efficiency performance to transmit the values measured by the sensor to the apparatus for detecting the decline of fuel efficiency performance.

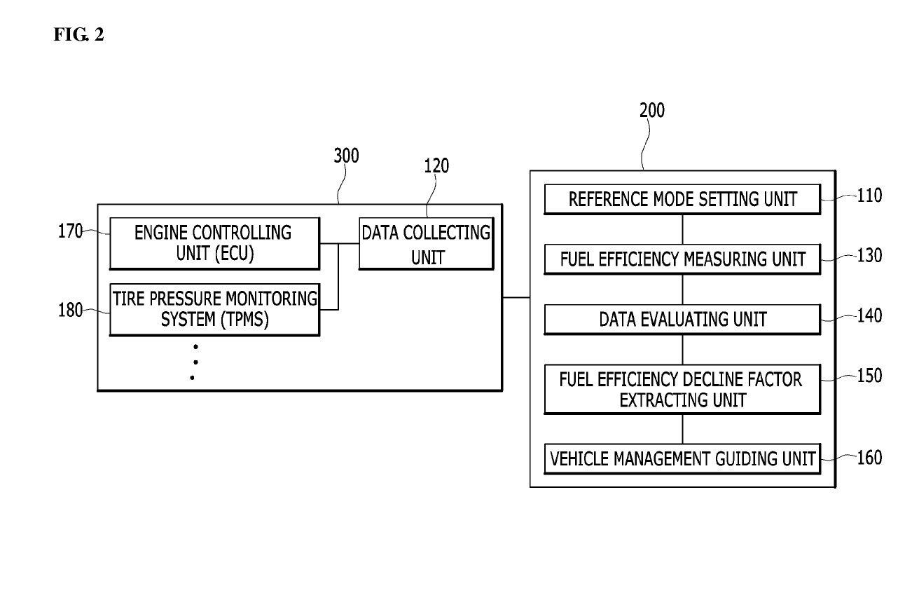

FIG. 2 shows the data collecting apparatus and the apparatus for detecting the decline of fuel efficiency performance according to the exemplary embodiment of the present invention. In FIG. 2, since components which are overlapped with the main components of FIG. 1 serve the same function, a detailed description thereof will be omitted. The exemplary embodiment of FIG. 2 shows an apparatus 200 for detecting a decline of fuel efficiency performance and a data collecting apparatus 300 separated. The data collecting apparatus 300 within the vehicle may be configured to collect data using sensors for each item from controlling apparatuses related to the decline of fuel efficiency by the data collecting unit 120 and transmit the data to the apparatus 200 for detecting the decline of fuel efficiency performance which may be extraneous to the vehicle via a wireless communication network. The apparatus 200 for detecting the decline of fuel efficiency performance which may be extraneous to the vehicle may be configured to measure average fuel efficiency based on the data for each item and determine whether the fuel efficiency performance is declined in the same method as the first exemplary embodiment, thereby informing the driver of the controlling apparatus causing the decline of fuel efficiency.

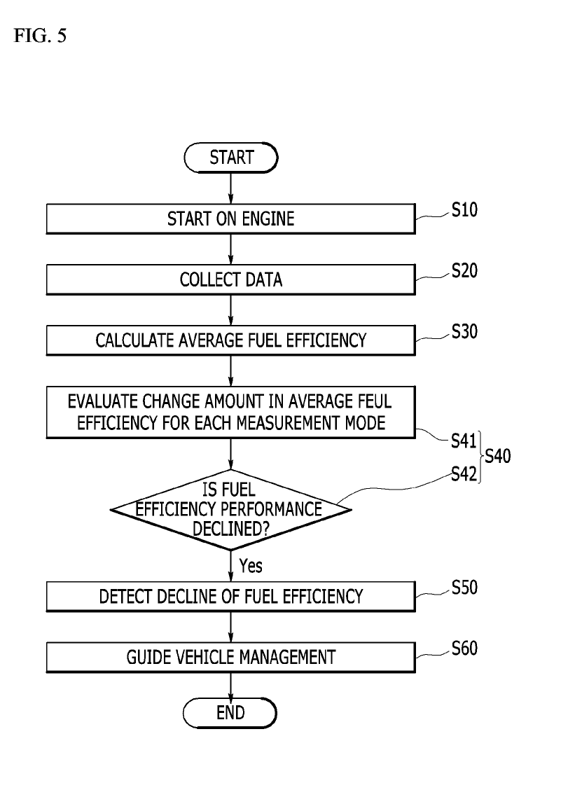

FIG. 5 is an exemplary method for detecting a decline of fuel efficiency performance according to an exemplary embodiment of the present invention. When an engine of a vehicle starts (S10) and a vehicle drive is initiated, a fuel efficiency measuring reference mode may be set in the vehicle or the reference mode may be set at the vehicle managing center which may be remote, which may be transmitted to the vehicle. In S20, the data for each item may be collected based on the fuel efficiency measuring reference mode and data of the decline of fuel efficiency performance may be collected from a plurality of controlling apparatuses. The data for each item may include at least one of a vehicle speed, a driving distance, a coolant temperature, an outdoor temperature, humidity, a vehicle height, an engine load, an engine revolution per minute (RPM), indicated horsepower, net horsepower, a gear stage, a battery voltage, a tire pressure, an idle time, an actual driving time, a fuel consumption amount, and the like.

In S30, average fuel efficiency may be measured based on the collected data for each item. In S40, whether the fuel efficiency performance is declined may be determined based on the measured value of the average fuel efficiency, wherein a change amount in the average fuel efficiency may be calculated (S41) and whether the fuel efficiency performance is declined may be determined (S42). Specifically, when an absolute value of the change in the average fuel efficiency exceeds a preset value, the fuel efficiency performance may be determined to be abnormal.

In S50, the controlling apparatus including the data of the decline of fuel efficiency performance may be determined and a decline factor of fuel efficiency may be detected. Specifically, when determining the controlling apparatus, whether the controlling apparatus is normal or abnormal may be determined based on a result obtained by comparing the data of the decline of fuel efficiency performance with a reference value of the controlling apparatus declining the fuel efficiency for each vehicle model. In S60, a notification may be output regarding the controlling apparatus causing the decline of fuel efficiency performance.

The collecting of the data (S20) may be performed within the vehicle, but other steps may be performed by receiving the data collected extraneous to the vehicle. In other words, the notification of the controlling apparatus causing the decline of fuel efficiency performance may be performed by a separate apparatus within the vehicle via wireless communication extraneous of the vehicle.

Since a detailed description in the method for detecting the decline of the fuel efficiency performance is overlapped with the description in the apparatus for detecting the decline of fuel efficiency performance, it will be omitted.

According to an exemplary embodiment of the present invention, a notification regarding a required check of a specific part of the vehicle may be output to the driver when a fuel efficiency state of the vehicle is monitored and the fuel efficiency is declined. In addition, a notification regarding a required vehicle check may be output to the driver at an appropriate timing by detecting factors related to the decline of the fuel efficiency according a performance degradation of the part in the vehicle in advance, and specifically, a vehicle management capable of maintaining an optimal fuel efficiency state by outputting notification regarding an aged part (e.g., a part that has experienced a failure) may be possible.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An apparatus for detecting a decline of fuel efficiency performance, comprising:
a memory configured to store program instructions; and
a processor configured to execute the program instructions, the program instructions when executed configured to:
set a fuel efficiency measuring reference mode;
measure average fuel efficiency based on data for each item based on the fuel efficiency measuring reference mode;
determine whether the fuel efficiency performance is declined based on the average fuel efficiency measured value;
determine a controlling apparatus causing the decline of fuel efficiency including data regarding the decline of fuel efficiency performance; and
output a notification regarding the controlling apparatus causing the decline of fuel efficiency performance.

2. The apparatus of claim 1, wherein the program instructions when executed are further configured to:
receive data collected for each item based on the fuel efficiency measuring reference mode upon driving a vehicle and data regarding the decline of fuel efficiency performance from a plurality of controlling apparatuses.

3. The apparatus of claim 1, wherein the data for each item includes at least one of the group consisting of: a vehicle speed, a driving distance, a coolant temperature, an outdoor temperature, humidity, a vehicle height, an engine load, an engine revolution per minute (RPM), indicated horsepower, net horsepower, a gear stage, a battery voltage, a tire pressure, an idle time, an actual driving time, and a fuel consumption amount.

4. The apparatus of claim 1, wherein the program instructions when executed are further configured to:
calculate a change in the average fuel efficiency based on the average fuel efficiency measured value; and
determine whether the fuel efficiency performance is declined based on the change in the average fuel efficiency.

5. The apparatus of claim 4, wherein when an absolute value of the change amount in the average fuel efficiency exceeds a preset value, the program instructions when executed are configured to determine the fuel efficiency performance to be abnormal.

6. The apparatus of claim 1, wherein the program instructions when executed are further configured to:
determine whether the controlling apparatus is normal or abnormal based on a result obtained by comparing the data of the decline of fuel efficiency performance with a reference value of the controlling apparatus declining fuel efficiency for each vehicle model.

7. The apparatus of claim 1, wherein the apparatus is connected wirelessly to an engine control unit and a tire pressure monitoring system.

8. The apparatus of claim 1, wherein the apparatus is interworked with a data collecting apparatus including an engine control unit, a tire pressure monitoring system, and a data collecting unit.

9. A method for detecting a decline of fuel efficiency performance, comprising:
setting, by a controller, a fuel efficiency measuring reference mode in a vehicle or at a remote center to transmit the reference mode to the vehicle;
receiving, by the controller, data for each item based on the fuel efficiency measuring reference mode upon driving the vehicle and data of the decline of fuel efficiency performance from a plurality of controlling apparatuses;
measuring, by the controller, average fuel efficiency based on the data for each item;
determining, by the controller, whether the fuel efficiency performance is declined based on the average fuel efficiency measured value;
determining, by the controller, a controlling apparatus including data of the decline of fuel efficiency performance and detecting a factor of the decline of fuel efficiency; and
outputting, by the controller, a notification regarding the controlling apparatus causing the decline of fuel efficiency performance.

10. The method of claim 9, wherein the determination of whether the fuel efficiency performance is declined, includes:
calculating, by the controller, a change in the average fuel efficiency based on the average fuel efficiency measured value; and
determining, by the controller, whether the fuel efficiency performance is declined based on the change in the average fuel efficiency.

11. The method of claim 10, wherein the determination of whether the fuel efficiency performance is declined when an absolute value of the change in the average fuel efficiency exceeds a preset value, includes:
determining, by the controller, that the fuel efficiency performance is abnormal.

12. The method of claim 9, wherein the detection of the factor of the decline of fuel efficiency, includes:
determining, by the controller, whether the controlling apparatus is normal or abnormal based on a result obtained by comparing the data of the decline of fuel efficiency performance with a reference value of the controlling apparatus declining fuel efficiency for each vehicle model.

13. A non-transitory computer readable medium containing program instructions executed by a controller, the computer readable medium comprising:
program instructions that set a fuel efficiency measuring reference mode in a vehicle or at a remote center to transmit the reference mode to the vehicle;
program instructions that receive data for each item based on the fuel efficiency measuring reference mode upon driving the vehicle and data of the decline of fuel efficiency performance from a plurality of controlling apparatuses;
program instructions that measure average fuel efficiency based on the data for each item;
program instructions that determine whether the fuel efficiency performance is declined based on the average fuel efficiency measured value;
program instructions that determine a controlling apparatus including data of the decline of fuel efficiency performance and detecting a factor of the decline of fuel efficiency; and
program instructions that output a notification regarding the controlling apparatus causing the decline of fuel efficiency performance.

14. The non-transitory computer readable medium of claim 13, wherein the determination of whether the fuel efficiency performance is declined, includes:
program instructions that calculate a change in the average fuel efficiency based on the average fuel efficiency measured value; and
program instructions that determine whether the fuel efficiency performance is declined based on the change in the average fuel efficiency.

15. The non-transitory computer readable medium of claim 14, wherein the determination of whether the fuel efficiency performance is declined when an absolute value of the change in the average fuel efficiency exceeds a preset value, includes:
program instructions that determine that the fuel efficiency performance is abnormal.

16. The non-transitory computer readable medium of claim 13, wherein the detection of the factor of the decline of fuel efficiency, includes:
program instructions that determine whether the controlling apparatus is normal or abnormal based on a result obtained by comparing the data of the decline of fuel efficiency performance with a reference value of the controlling apparatus declining fuel efficiency for each vehicle model.
